(19) United States
(12) Patent Application Publication
(10) Pub. No.: US 2005/0276882 A1
(43) Pub. Date: Dec. 15, 2005

(54) Pet food, pet food pellets and process for making same

(76) Inventor: William W. Bishop, Wilton, CT (US)

Correspondence Address: Paul D. Greeley, Esq.;Ohlandt, Greeley, Ruggiero & Perle, L.L.P., 10th Floor, One Landmark Square, Stamford, CT, 06901-2682, US

(21) Appl. No.: 10/866,069

(22) Filed: Jun. 11, 2004

(51) Int. Cl. A23L 1/30

(52) U.S. Cl. 426/72

(57) ABSTRACT

A pet food that comprises a mixture of kibbles and pellets. The pellets comprise a plurality of ingredients, one or more of which are nutrients, such as antioxidants, vitamins or minerals, that have a potency that is free of substantial thermal degradation. The pellets are made by a cold forming process at temperatures below the thermal degradation temperatures of the ingredients.

### FIELD OF THE INVENTION

This invention relates to pet food and a process for making the pet food, as well as pet food pellets (“bits”). In particular, the pet food is especially suitable for dog food and/or cat food.

### BACKGROUND OF THE INVENTION

Pet food generally consists of kibbles that are made with ingredients, such as, a protein source (e.g., lamb, chicken or fish), whole grains, fresh vegetables, fruit and the like. The kibbles are commonly made with a baking or heat extrusion process that forms the kibble under high temperature into any desired shape. Additives, such as antioxidants, nutrients, vitamins, minerals and the like, are commonly blended with the kibble ingredients prior to heating/forming.

A disadvantage of pet food products formed as described above is that the heat of the process degrades the potency of most antioxidants and vitamins. For example, vitamin C, when exposed to heat above its temperature of degradation, can lose up to 75% of its potency. In addition, high temperatures can destroy certain enzymes and amino acids and/or change them into indigestible components.

Thus, there is a need for a pet food that eliminates the potency loss of heat degradable additives.

### SUMMARY OF THE INVENTION

The present invention satisfies this need with a two part pet food comprising kibbles and pellets. The pellets include one or more ingredients, which have a potency that is without substantial thermal degradation. This satisfies the aforementioned need by providing pet food product in which the additives are free of substantial thermal degradation.

An embodiment of the pet food of the present invention comprises a mixture of at least one kibble and at least one pellet. The pellet comprises one or more ingredients, which have a potency that is without substantial thermal degradation.

In another embodiment of the pet food of the present invention, the pellet has a hardness similar to a hardness of the kibble.

In another embodiment of the pet food of the present invention, at least one of the ingredients is selected from the group consisting of: barley grass, parsley, fish oil, whole garlic cloves, glucosamine, ground flax seed, oatmeal, dried kelp, lecithin, spirulina, Yucca, and Vitamin C,

In another embodiment of the pet food of the present invention, one or more of the ingredients is selected from the group consisting of: antioxidants, nutrients, vitamins and/or minerals.

In another embodiment of the pet food of the present invention, the pellet is formed without substantial thermal degradation of the potency.

In another embodiment of the pet food of the present invention, the kibble is one of a plurality of kibbles and the pellet is one of a plurality of pellets.

In another embodiment of the pet food of the present invention, the pellets have a non-powdery granularity.

In another embodiment of the pet food of the present invention, the kibbles are formed at temperatures in excess of any potency degradation temperatures of the ingredients.

In another embodiment of the pet food of the present invention, the potency degradation temperatures are above about 160° F.

In an embodiment of the process of the present invention, pellets are with kibbles to form a mixture thereof. The pellets include one or more ingredients, which have a potency that is without substantial thermal degradation.

In another embodiment of the process of the present invention, at least one of the ingredients is selected from the group consisting of: barley grass, parsley, fish oil, whole garlic cloves, glucosamine, ground flax seed, oatmeal, dried kelp, lecithin, spirulina and Yucca, Vitamin A, Beta-Carotene, Vitamin C, Vitamin D, Vitamin E, Niacin, Riboflavin, Vitamin B-12, Pantothenate, Pyridoxine and Folic Acid.

In another embodiment of the process of the present invention, one or more of the ingredients is selected from the group consisting of: antioxidants, nutrients, vitamins and/or minerals.

In another embodiment of the process of the present invention, the pellets have a non-powdery granularity.

In another embodiment of the process of the present invention, the kibbles are formed at temperatures in excess of any potency degradation temperatures of the ingredients.

In another embodiment of the process of the present invention, the potency degradation temperatures are above about 150° F.

In an embodiment of the pet food pellet of the present invention, the pet food pellet comprises a plurality of ingredients. One or more of the ingredients has a potency that is without substantial thermal degradation.

In another embodiment of the pet food pellet of the present invention, pellet has a granularity greater than that of a powder.

In another embodiment of the pet food pellet of the present invention, said pellet has a moisture level of about 5% or more.

### BRIEF DESCRIPTION OF THE DRAWING

Other and further objects, advantages and features of the present invention will be understood by reference to the following specification in conjunction with the sole FIGURE of the drawing.

### DESCRIPTION OF THE PREFERRED EMBODIMENT

Referring to the FIGURE, a manufacturing system 10 is arranged to produce the pet food of the present invention as a mixture 12 of kibbles 14 and pellets 16. Kibbles 14 are made by any suitable kibble producing system (not shown) that combines kibble ingredients into a desired kibble shape. The kibble shape shown in the FIGURE is an example and other shapes are possible. The kibble ingredients typically include, by way of example, a protein source (e.g., chicken, lamb, fish and the like), vegetables, fruits, oils, grain and the like. The kibble producing system typically combines the ingredients in a process that uses heat as in an extruder or an oven to form kibbles 14. Temperatures used by such systems can reach 250° F. to 300° F.

Pellets 16 are a precise blend of all natural nutrients and antioxidants that are easily assimilated so pets, for example, dogs and cats, receive the maximum health and protection benefits. A partial list of ingredients, and their associated benefits is shown in Table 1 below.

TABLE 1
Barley Grass - a good source of chlorophyll, fiber and phytochemicals.
It is known to be beneficial in the treatment of arthritis, diabetes, kidney,
liver disease and cancer.
Parsley - a rich source of chlorophyll, which is a natural healer. Because
chlorophyll is chemically close to hemoglobin, parsley will help to
regenerate new red blood cells. It is also a natural diuretic and will help to
maintain a healthy urinary tract.
Fish Oil - fats and fatty acids are the energy source for the body.
Whole Garlic Cloves - a potent antioxidant that helps to thin the blood,
strengthen the heart and maintain good circulation. It contains a natural
antibiotic and antiseptic called allicin and is also known to help fight
cancer.
Glucosamine - has been known to help prevent arthritis and to maintain
the health of connective tissue, tendons, ligaments and cartilage.
Ground Flax Seed - contains flax seed oil, which is the richest source of
the essential omega 3 fatty acids (linolenic acid). Flax is a good source of
essential amino acids and contains all the essential vitamins and minerals
required by dogs and cats. Flax is beneficial for its anti-inflammatory
effect and has been known to help
Oatmeal - a good source of complex carbohydrates and beneficial fiber.
Oatmeal helps to prevent heart disease, diabetes and cancer; helps to lower
cholesterol and maintain the proper levels of blood sugar.
Dried Kelp - a good source of essentials vitamins and minerals (including
iodine). Kelp is a good antioxidant and is known to be beneficial in help-
ing to fight cancer.
Lecithin - is rich in choline and helps the proper functioning of the skin,
liver, brain and nervous system, lecithin also helps in the digestion and
emulsification of fats.
Spirulina - a blue-green algae that contains vitamins, minerals and anti-
oxidants. It is a potent antioxidant, and helps the body strengthen its own
DNA for tissue repair and healing.
Yucca - has been known to have anti-inflammatory effect on tendons and
joint cartilage. Known to be beneficial for anemia, heart, skin, eyes
(cataracts) and cancer.
Vitamin A - helps promote healthy skin, bone, connective tissue, eyes and
is essential for reproduction. Helps the body fight environmental toxins,
cancer and the effects of aging.
Beta-Carotene - a potent antioxidant, which is known to help with many
chronic degenerative diseases.
Vitamin C - a potent antioxidant and immune system booster. Vitamin C
has been known to help prevent bacterial, viral and degenerative diseases
such as arthritis, diabetes, auto immune disease and cancer.
Vitamin D - helps promote healthy skin, bone, connective tissue and heart
muscle function. Vitamin D also helps absorption and utilization of both
calcium and phosphorus.
Vitamin E - a potent antioxidant that helps to improve circulation and
cardiac output.
Niacin - helps in the metabolism of fats (fatty acids) and carbohydrates.
Niacin is important for the proper health of the central nervous and GI
systems and the skin.
Riboflavin - helps the digestion of fats and carbohydrates and for healthy
skin and coat.
Thiamin - helps in the metabolism of fats (fatty acids) and carbohydrates.
Thiamin is important for the proper health of the central nervous system,
muscles and skin.
Vitamin B12 - necessary for the metabolism of amino acids, sugar and
fats. Known to help red blood cell production, liver function and helps
strengthen the immune system.
Pantothenate - helps the metabolism of fats, fatty acids and the production
of hormones, sterols and enzymes. It is helpful in the prevention of
diseases of the GI tract and the immune system, particularly diseases of
the adrenal gland.
Pyridoxine - helps in the metabolism of amino acids and the production of
red blood cells and GI tract juices.
Folic Acid - helps the metabolism of amino acids and the production of
red blood cells, hormones and antibodies.

The potency of these ingredients (especially antioxidants, vitamins, and the like) is thermally degradable when subjected to temperatures such as those reached in the kibble making processes. For the purpose of this description, a potency degradation temperature of an ingredient is that temperature at which the potency of the ingredient thermally degrades or begins to thermally degrade. For example, the potency degradation temperature of most ingredients begins around 160° F.

The ingredients of pellets 16 are combined by a typical processing system (not shown) that uses cold forming techniques, that is, techniques, in which the temperatures are less than the potency degradation temperatures of all of the ingredients. For example, one such processing system starts with a dry mixing process to achieve a homogenous dry (4% to 6% moisture) powder blend of the pellet ingredients. The dry powder blend is then cold-formed using an extruder that raises the moisture level to a desired level via steam and water jets in the extruder, while keeping the mixture cool using water-cooled jackets on the barrel of the extruder. The desired moisture level is preferably above about 10% and more preferably is in a range of about 14% to about 17%. The temperature of the paste does not exceed 150° F. during the process. The paste is cut into small “bits” as it exits the extruder. The extruded pellets are then sent through a continuous dryer where the moisture level is adjusted down to a range of about 5% to about 10% and drying temperatures do not exceed 125° F.

Thus, the cold forming process starts with a dry powdery blend and ends with higher moisture non-powdery pellets 16. That is, pellets 16 have a granularity that is non-powdery and a moisture level that is higher than that of the dry powdery blend. Also, pellets 16 have a hardness similar to the hardness of the base kibbles. Mixing kibbles 14 and pellets 16 provides a homogeneous pet food product that avoids stratification that might occur with powders and the like. For example, a powder would tend to settle to the bottom of a container. Pet food mixture 12 of the present invention avoids the stratification since kibbles 14 and pellets 16 have a similar hardness that permits use of a dry mixing process. Moreover, potencies of the ingredients of pellets 16 are without substantial thermal degradation. That is, any potency variation from full potency is minimal.

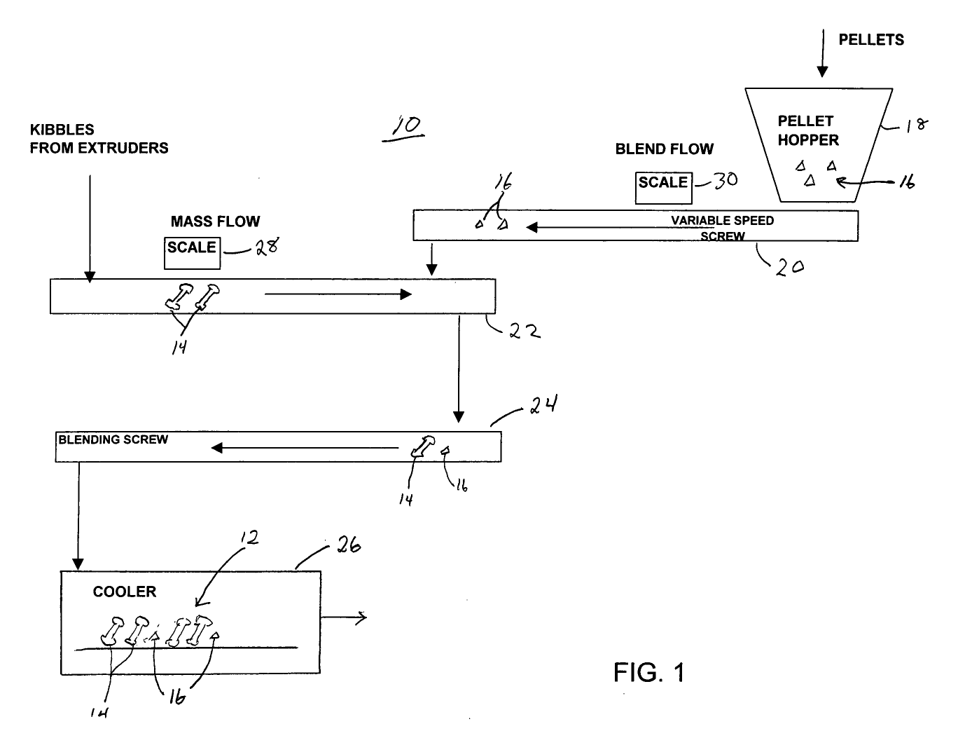

Still referring to the FIGURE, manufacturing system 10 includes a hopper 18 that receives pellets 16. Hopper 18 delivers pellets 16 to a pellet screw conveyor 20 that conveys pellets 16 from right to left in FIG. 2. Dried kibbles 14 are fed to a kibble screw conveyor 22 that conveys kibbles 14 from left to right in FIG. 2. Pellets 16 are discharged from pellet screw conveyor 20 into the right hand end of kibble screw conveyor 22. The kibble 14 and pellet 16 combination is discharged from kibble screw conveyor 22 to a blending screw conveyor 24 that mixes kibble 14 and bits 16 to form pet food mixture 12 that flows from blending screw conveyor 24 to cooler 26. After cooling, for example to ambient temperature, pet food mixture 12 is delivered from cooler 26 to a storage hopper (not shown).

Manufacturing system 10 dry blends kibbles 14 and pellets 16 together at a pre-determined weight ratio to deliver a desired pellet inclusion as a function of pellet potency. Kibbles 14 and pellets 16 are blended on a weight basis using pellet screw conveyor 20 and kibble screw conveyor 22, which for the shown embodiment are variable screw conveyors, and blend screw conveyor 24. Manufacturing system 10 a nuclear scale 28 and a nuclear scale 30 that are linked to one another. Nuclear scale 28 is located to measure the mass flow of kibbles 14 from the extruders and establishes a set point for kibble flow. Nuclear scale 30 is located to monitor the pellet flow of hopper 18 as compared to the set point. A controller (not shown) proportions the required bit mass flow to a tolerance, which in one embodiment is +/−1 to 1.5% of inclusion target.

A proportional-integral-derivative (PID) loop adjusts the pellet flow from hopper 18 through programmable controller according to the variation in mass flow. For example, if the target bit inclusion ratio is 10 percent, and the kibble flow rate from extruders is 90 lb./min, then the bit flow would be adjusted to deliver 10 lb./min to deliver an overall 10% inclusion rate.

Thus, the pet food of the present invention comprises a two-part dry food, namely, kibbles and pellets. The pellets are cold-formed to preserve the full potency of all ingredients without substantial thermal degradation. This is in contrast to prior pet foods in which the potency of antioxidants, vitamins and minerals is significantly reduced by the heat of the kibble forming process.

The present invention having been thus described with particular reference to the preferred forms thereof, it will be obvious that various changes and modifications may be made therein without departing from the spirit and scope of the present invention as defined in the appended claims.

1. A pet food comprising a mixture of at least one kibble and at least one pellet, wherein said pellet comprises one or more ingredients, which have a potency that is without substantial thermal degradation.

2. The pet food of claim 1, wherein said pellet has a hardness similar to a hardness of said kibble.

3. The pet food of claim 1, wherein at least one of said ingredients is selected from the group consisting of: barley grass, parsley, fish oil, whole garlic cloves, glucosamine, ground flax seed, oatmeal, dried kelp, lecithin, spirulina, Yucca, and Vitamin C, Vitamin A, Beta-Carotene, Vitamin D, Vitamin E, Niacin, Riboflavin, Vitamin B-12, Pantothenate, Pyridoxine and Folic Acid.

4. The pet food of claim 1, wherein one or more of said ingredients is selected from the group consisting of: antioxidants, nutrients, vitamins and/or minerals.

5. The pet food of claim 1, wherein said pellet is formed without substantial thermal degradation of said potency.

6. The pet food of claim 1, wherein said kibble is one of a plurality of kibbles and said pellet is one of a plurality of pellets.

7. The pet food of claim 6, wherein said pellets have a non-powdery granularity.

8. The pet food of claim 6, wherein said kibbles are formed at temperatures in excess of any potency degradation temperatures of said ingredients.

9. The pet food of claim 8, wherein said potency degradation temperatures are above about 150° F.

10. A process of making pet food comprising:
mixing pellets with kibbles to form a mixture thereof, wherein said pellets include one or more ingredients, which have a potency that is without substantial thermal degradation.

11. The process of claim 10, wherein at least one of said ingredients is selected from the group consisting of: barley grass, parsley, fish oil, whole garlic cloves, glucosamine, ground flax seed, oatmeal, dried kelp, lecithin, spirulina and Yucca, and Vitamin C, Vitamin A, Beta-Carotene, Vitamin D, Vitamin E, Niacin, Riboflavin, Vitamin B-12, Pantothenate, Pyridoxine and Folic Acid.

12. The process of claim 10, wherein one or more of said ingredients is selected from the group consisting of: antioxidants, nutrients, vitamins and/or minerals.

13. The process of claim 10, wherein said pellets have a non-powdery granularity.

14. The process of claim 10, wherein said kibbles are formed at temperatures in excess of any potency degradation temperatures of said ingredients.

15. The process of claim 14, wherein said potency degradation temperatures are above about 150° F.

16. A pet food pellet comprising a plurality of ingredients, wherein one or more of said ingredients have a potency that is without substantial thermal degradation.

17. The pet food pellet of claim 16, wherein said pet food pellet has a granularity greater than that of a powder.

18. The pet food pellet of claim 16, wherein said pellet has a moisture level of about 5% or more.
